(19) United States
(12) Patent Application Publication
(10) Pub. No.: US 2005/0008758 A1
(43) Pub. Date: Jan. 13, 2005

(54) Methods of preparing meat analogues, meat analogues, and foodstuffs comprising meat analogues

(76) Inventors: Gerard T. Howse, Mississauga (CA); Kuldip Sidhu, Mississauga (CA); David D. Grex, Chicago, IL (US)

Correspondence Address: BRINKS HOFER GILSON & LIONE, P.O. BOX 10395, CHICAGO, IL, 60610, US

(21) Appl. No.: 10/616,700

(22) Filed: Jul. 9, 2003

(51) Int. Cl. A23J 1/00

(52) U.S. Cl. 426/656

(57) ABSTRACT

Methods of preparing meat analogues are described that include (a) hydrating a textured vegetable protein to form a hydrated textured vegetable protein; (b) preparing a protein base containing vital wheat gluten, milk-derived protein, and water; and (c) combining the hydrated textured vegetable protein and the protein base. Meat analogues and foodstuffs containing meat analogues are also described.

### FIELD OF THE INVENTION

The present invention relates to meat analogues for use in foodstuffs and to methods of their preparation.

### BACKGROUND

Protein is a major source of nutrition, the consumption of which is an important part of well-balanced diets. Although meat is perhaps the most common source of protein, the presence of certain components in the meat (e.g., cholesterol) may present a health risk to individuals who consume excessive quantities of meat and/or who may already be at risk for certain health problems, such as atherosclerosis. Furthermore, certain individuals, regardless of the nutritional advantages to be gained from meat consumption, choose not to consume meat due to certain religious and/or personal beliefs. Thus, the development of alternative non-meat sources of protein remains an important goal within the food industry.

Over the years, considerable effort has been spent in an effort to develop coarse, ground meat analogue products that have a meat-like flavor and texture but which do not contain any meat. Soy-based products have emerged as being particularly popular in this regard. However, soy-based products are often characterized by having an undesirable bean-like soy flavor instead of the desired meat-like flavor. In addition, the organoleptic properties of soy-based products are frequently undesirable, characterized by having a soft, mushy texture and/or a dry mouthfeel.

Accordingly, the development of meat analogues that avoid the above-mentioned drawbacks of soy-based products remains of considerable interest to those in the food industry.

### SUMMARY

The scope of the present invention is defined solely by the appended claims, and is not affected to any degree by the statements within this summary.

By way of introduction, a first method of preparing meat analogues embodying features of the present invention includes (a) hydrating a textured vegetable protein to form a hydrated textured vegetable protein; (b) preparing a protein base containing vital wheat gluten, milk-derived protein, and water; and (c) combining the hydrated textured vegetable protein and the protein base.

A second method of preparing meat analogues embodying features of the present invention includes (a) adding a first portion of water to a textured wheat protein to form a hydrated textured wheat protein; (b) preparing a protein base containing a powdered protein base and a second portion of water, wherein the powdered protein base contains vital wheat gluten and milk-derived protein; (c) forming a binder containing a vegetable fat, a third portion of water, and a component selected from the group consisting of modified cellulose, modified cornstarch, and a combination thereof; and (d) combining the hydrated textured wheat protein, the protein base, and the binder.

A third method of preparing meat analogues embodying features of the present invention includes (a) adding a first portion of water to a textured wheat protein to form a hydrated textured wheat protein, wherein the textured wheat protein comprises from about 5% to about 25% by weight of the meat analogue and the first portion of water comprises from about 20% to about 50% by weight of the meat analogue; (b) preparing a protein base comprising a powdered protein base and a second portion of water, wherein the powdered protein base comprises vital wheat gluten and milk-derived protein, the powdered protein base comprises from about 3% to about 7% by weight of the meat analogue, and the second portion of water comprises from about 6% to about 9% by weight of the meat analogue; (c) forming a binder comprising hydrogenated solid fat, a third portion of water, and a component selected from the group consisting of methyl cellulose, modified cornstarch, and a combination thereof, wherein the methylcellulose comprises from about 3% to about 7% by weight of the meat analogue, the modified cornstarch comprises from about 3% to about 7% by weight of the meat analogue, the hydrogenated solid fat comprises from about 7% to about 13% by weight of the meat analogue, and the third portion of water comprises from about 3% to about 6% by weight of the meat analogue; (d) combining the hydrated textured wheat protein, the protein base, and the binder; and (e) blending the hydrated textured wheat protein, the protein base, and the binder in a blender until the meat analogue has a consistent appearance.

A first series of meat analogues embodying features of the present invention are prepared in accordance with methods such as described above.

A second series of meat analogues embodying features of the present invention includes vital wheat gluten, milk-derived protein, and a textured wheat protein.

A first series of foodstuffs embodying features of the present invention contains meat analogues prepared in accordance with methods such as described above.

A second series of foodstuffs embodying features of the present invention includes a meat analogue containing vital wheat gluten, milk-derived protein, and a textured wheat protein.

### DETAILED DESCRIPTION

Meat analogues and processes for preparing the same have been discovered which provide a meatless product that closely mimics the texture of meat while exhibiting a superior bind and a firmer texture as compared to commercially available meat analogues. Briefly stated, meat analogues embodying features of the present invention desirably include (1) a powdered protein base, (2) a textured vegetable protein, (3) a binder, (4) a vegetable fat, and (5) a seasoning. Each of these fractions is combined with specific amounts of water under specific mixing conditions in order to develop proper rheologies in the raw form, which can be translated into desired textures in the finished form.

Throughout this description and in the appended claims, the following definitions are to be understood:

The phrase “textured vegetable protein” refers to a fibrous vegetable protein having a look and texture similar to that of meat as well as a low flavor profile with minimal aftertaste. Preferably, the textured vegetable protein is textured wheat protein.

The term “hydrating” is synonymous with the phrase “adding water.”

The phrase “gluten-containing material” refers to any product that contains gluten, which upon addition of water and mixing, preferably exhibits physical properties such as elasticity and gumminess. Representative examples include but are not limited to vital wheat gluten, wheat flour, milk protein, and the like, and combinations thereof.

The phrase “vital wheat gluten” refers to those forms of dried wheat gluten that have been subjected to only minimal or no heat denaturation during drying. Upon reconstitution with water, vital wheat gluten shows physical properties (e.g., elasticity, gumminess, etc.) similar to those of freshly prepared wet wheat gluten.

The phrase “milk-derived protein” refers to the serum remaining after solids (e.g., fat, casein) have been removed from milk and to products derived from this serum upon additional processing (e.g., drying). By way of example, the phrase “milk-derived protein” includes but is not limited to whey protein which, for example, may be present as whey powder.

The phrase “percent by weight of the meat analogue” refers to the weight percent of an ingredient in relation to the weight of the total formula. The calculation is performed based on initial amounts of ingredients added and is not adjusted to reflect any changes that occur during processing and mixing (e.g., weight reduction due to evaporation of water, etc.).

Meat analogues embodying features of the present invention are prepared in a series of phases further described below, which include (1) hydrating a textured vegetable protein to form a hydrated textured vegetable protein; (2) preparing a protein base comprising a gluten-containing material, milk-derived protein, and water, wherein vital wheat gluten is a presently preferred gluten-containing material; and (3) combining the hydrated textured vegetable protein and the protein base.

In phase 1, the textured protein is hydrated by being soaked in water for a time period of preferably between about 2 and about 15 hours, more preferably for a time period of between about 8 and about 12 hours. The textured wheat protein is a primary component of the meat analogues embodying features of the present invention and provides a desired finished texture without introducing objectionable flavors. In an alternative process for carrying out phase 1 in accordance with the present invention, the hydrated textured protein may be placed in a vacuum tumbler and mixed under vacuum at pressures of preferably between about 20 and about 25 inches, at speeds of preferably between about 30 and about 50 RPMs, for a time period of preferably between about 60 and about 90 minutes, thereby allowing more rapid hydration of the textured protein.

In phase 2, the protein base is prepared by slowly adding water to the powdered protein base, which contains a combination of vital wheat gluten and a milk-derived protein, in a mixer to form an elastic mass. The water is preferably added over a time period of between about 1 and about 5 minutes, depending on batch size. The protein base provides the “glue” that holds the material together. After addition of water, the mixture is mixed with sufficient energy, so as to extract soluble gluten and provide a final protein base having the characteristic of wet, elastic dough containing free water. Representative mixers for use in accordance with the present invention include but are not limited to ribbon blenders, bowl mixers, silent cutters, vertical Hobart-type mixtures, and the like, and combinations thereof. Mixing times and speeds will vary according to both the type of equipment used and the batch size. However, speeds of between about 10 and about 60 RPMs are typically useful in accordance with the present invention. Temperatures should preferably be kept as constant as possible, but may vary within the ranges typically associated with meat products (e.g., preferably between about 28 and about 40 degrees Fahrenheit).

A first presently preferred procedure for preparing a protein base embodying features of the present invention (i.e., for conducting phase 2 above) includes mixing a dry protein base with water in a vertical Hobart-style paddle mixer at low speed until a desired elasticity is achieved. A second presently preferred procedure for preparing a protein base embodying features of the present invention includes developing the protein base in a silent cutter with a combination of water and ice to control temperature. In this second procedure, the weight of water will correspond to the combined weight of water and ice. In carrying out the second procedure, the water and ice are first added at slow speed and mixed. Next, the product is chopped at high speed for between about 3 and about 10 minutes until a desired elasticity is achieved.

In phase 3, a binder is prepared. The binder includes water, a vegetable fat, and a component selected from the group consisting of modified cellulose, modified cornstarch, wheat gluten, and combinations thereof. During subsequent cooking, the modified cellulose provides texture and the modified corn starch provides bind and water binding and management properties. The vegetable fat provides succulence and desirable eating qualities. Preferably, the modified cellulose is methylcellulose and the binder contains a combination of methylcellulose and modified cornstarch. Preferably, the methylcellulose comprises from about 2% to about 10% by weight of the meat analogue, more preferably from about 3% to about 7%. Preferably, the modified cornstarch comprises from about 1% to about 10% by weight of the meat analogue, more preferably from about 2% to about 7%. Moreover, it is desirable that the vegetable fat is a hydrogenated or a partially hydrogenated solid fat. More preferably, the vegetable fat is hydrogenated solid fat having a melting point between about 70° F. and about 150° F., more preferably between about 90° F. and about 120° F. Preferably, the hydrogenated solid fat comprises from about 5% to about 17% by weight of the meat analogue, more preferably from about 7% to about 13%. Desirably, the hydrogenated solid fat is a partially hydrogenated mixture of soybean and cottonseed oil such as that sold under the tradename HUMKOTE by A. C. Humko (Memphis, Tenn.). In alternative embodiments described below, the hydrogenated fat in the binder may either be reduced (e.g., by about 50%) or completely replaced (e.g., by using a pre-gel potato starch in place of the above-mentioned hydrogenated soybean oil).

In phase 4, the products of phases 1 and 2 and 3 are mixed, preferably in a blender (e.g., a ribbon blender), together with seasoning until product consistency is achieved. Seasoning may include salt, flavorings, and spices that provide flavor and mouth feel during eating. Desirable seasonings include those that impart a meat-like flavor to composition (e.g., beef, chicken, fish, etc.). Flavor profiles of the seasonings may be customized to meet the requirements of a given foodstuff to be manufactured. The seasoning is typically added in minor amounts.

In subsequent phases, the resultant material may then be processed through a grinder using plates preferably ranging from 1/16″ to ⅜″ to evenly break down the coarse ingredients and provide a material having the consistency and appearance of fresh ground meat. The grinding process further develops the gluten thereby improving bind of the final product. The ground material should be handled in a manner analogous to that of fresh ground meat for reasons of microbial safety. Of course, the material may subsequently be shaped into all manner of food products including but not limited to burgers, sausage, nuggets, chicken, cutlets, meatballs, meatloaves, and the like.

Presently desirable ranges of ingredients and representative suppliers of ingredients for preparing meat analogues in accordance with the present invention are summarized in Table 1 below. It is to be understood that the ingredients shown in the Tables below may be available from a variety of suppliers other than those identified. Furthermore, it is to be understood that ingredients obtained from suppliers other than the representative suppliers identified in the Tables may be used in accordance with the present invention.

TABLE 1

| | | % BY WEIGHT | |
|---|---|---|---|
| | | OF TOTAL | |
| PHASE | INGREDIENT | FORMULA | SUPPLIER |
| 1 | Textured Wheat | 5-25 | WHEATEX |
| | Protein | | Midwest Grain |
| | | | Products, Inc. |
| | | | (Atchison, KA) |
| | First Portion of | 20-50 | |
| | Water | | |
| 2 | Powdered | 3-7 | PROLITE 80 |
| | Protein Base | | Archer Daniels |
| | (vital wheat | | Midland Company |
| | gluten and whey | | (Decatur, IL) Whey |
| | protein | | Protein Concentrate, |
| | concentrate) | | 34-35% Canadian |
| | | | Inovatech, Inc. |
| | | | (Abbotsford, |
| | | | British Columbia) |
| | Second Portion | 6-9 | |
| | of Water | | |
| 3 | Methylcellulose | 3-7 | METHOCEL A4M |
| | | | Dow Chemical Company |
| | | | (Midland, MI) |
| | Modified | 3-7 | COLFLO67 |
| | Cornstarch | | National Starch and |
| | (acylated waxy | | Chemical Company |
| | maize) | | (Bridgewater, NJ) |
| | Hydrogenated | 7-13 | HUMKOTE 106 |
| | Solid Fat | | A. C. Humko |
| | | | (Memphis, TN) |
| | Third Portion of | 3-6 | |
| | Water | | |

The powdered protein base in Table 1 contains vital wheat gluten in combination with milk-derived protein. The vital wheat gluten preferably comprises from about 75% to about 95% by weight of the powdered protein base, and the milk-derived protein preferably comprises from about 5% to about 25% by weight of the powdered protein base. A presently desirable powdered protein base includes about 87% by weight of vital wheat gluten and about 13% by weight of milk-derived.

Meat analogues embodying features of the present invention are prepared in accordance with the procedures described above, and contain vital wheat gluten, milk-derived protein, and a textured wheat protein.

The amount of protein present in meat analogue formulations in accordance with the present invention affects the texture and organoleptic properties thereof. By way of example, it has been found that the addition of too much protein results in a softer, elastic material, whereas the addition of too little protein results in a brittle, short material.

The type of textured wheat protein used in accordance with the present invention is not restricted, with the material sold under the tradename WHEATEX being presently desirable. All sizes and shapes of textured wheat protein have been contemplated for use in accordance with the present invention including the materials shown in Table 2 below.

TABLE 2

| WHEATEX SERIES | DESCRIPTION |
|---|---|
| 16 | coarse ground powder |
| 240, 2240 | 6 mm flakes |
| 400 | 10 mm flakes |
| | 1.5-2 cm width |
| 1500 | 2-3 cm length |
| | 1-3 mm thick |
| 2120 | 3 mm flakes |
| 2400 | 15 mm chunks |
| | 1-2 cm diameter |
| 6000 | 4-6 cm length |

Foodstuffs embodying features of the present invention include meat analogues of a type described above. While the meat analogues in accordance with the present invention may be shaped or alternatively amorphous, it is presently desirable that they be shaped in the form of a conventional food product. It should be emphasized that meat analogues in accordance with the present invention may be used as meat replacements to provide a meatless foodstuff or as meat enhancers/extenders to replace a portion of the meat that would normally be present in a foodstuff (in this latter application, the meat analogue functions similarly to a bulking agent).

In accordance with the present invention, meat analogues which contain reduced amounts of soy-based materials as compared to conventional foodstuffs may be provided. Alternatively, in accordance with the present invention, meat analogues that are completely soy-free (i.e., which do not contain any soy-based materials) may likewise be provided. Inasmuch as soy-based foodstuffs typically have undesirable flavor and/or organoleptic properties (e.g., mouthfeel), it is presently preferred that the meat analogues embodying features of and prepared in accordance with the present invention are soy-free.

The representative and non-limiting meat analogue formulae shown in Tables 3-5 below illustrate features in accordance with the present invention, and are provided solely by way of illustration. They are not intended to limit the scope of the appended claims or their equivalents.

TABLE 3
Formula for a “Beef-Style” Burger

| INGREDIENT | WEIGHT PERCENT |
|---|---|
| Protein Base | 5.3 |
| Hydration Water | 8.8 |
| WHEATEX 1502C | 6.7 |
| Hydration Water | 27.3 |
| WHEATEX 240M | 12.1 |
| Hydration Water | 15.8 |
| Binders and Seasoning | 10.0 |
| | (6% binder + 4% seasoning) |
| HUMKOTE 106 | 10.0 |
| Water | 4.0 |

TABLE 4
Formula for a “Chicken-Style” Burger

| INGREDIENT | WEIGHT PERCENT |
|---|---|
| Protein Base | 5.0 |
| Hydration Water | 8.4 |
| WHEATEX 1501 | 16.8 |
| Hydration Water | 43.8 |
| Binders and Seasoning | 11.8 |
| | (7% binder + 4.8% seasoning) |
| HUMKOTE 106 | 10.0 |
| Water | 4.2 |

TABLE 5
Formula for a “Chicken-Style” Coating for a Cutlette or Nugget

| INGREDIENT | WEIGHT PERCENT |
|---|---|
| Protein Base | 5.0 |
| Hydration Water | 8.3 |
| WHEATEX 1501 | 17.1 |
| Hydration Water | 44.3 |
| Binders and Seasoning | 11.1 |
| | (7% binder + 4.1% seasoning) |
| HUMKOTE 106 | 10.0 |
| Water | 4.2 |

Each of the above-described formulae is processed according to the methods described above. For example, in phase 1, WHEATEX 1501 is pre-hydrated with water overnight in a ratio of 1 part to 2.6 parts. In phase 2, water is slowly added to the protein base to form an elastic mass. The amounts of gluten-containing material (e.g., vital wheat gluten), milk-derived protein, and water, as well as the amount of energy input (e.g., mixing time) are controlled to provide the desired degree of elasticity of the elastic mass. The resultant mass resembles wet, elastic dough containing some additional free water. In the final phase, remaining ingredients (e.g., seasoning, HUMKOTE 106, and water) are added and the mixture is mixed to a desired consistency.

As noted above, alternative embodiments of the present invention provide reduced fat formulations wherein all or a portion of the hydrogenated fat normally added to the binder may be replaced. A pre-gel potato starch such as that sold under the tradename PENGEL by Penford Products (Denver, Colo.) is a presently preferred replacement for hydrogenated fat. A representative and non-limiting reduced fat formulation in accordance with the present invention is shown in Table 6 below.

TABLE 6
Reduced Fat Formulation

| INGREDIENT | WEIGHT PERCENT |
|---|---|
| Protein Base | 5.0000 |
| Hydration Water | 8.3300 |
| WHEATEX 1501 | 16.8194 |
| Hydration Water | 43.7306 |
| Binder and Seasoning | 11.8500 |
| HUMKOTE 106 | 5.0000 |
| PENGEL 8 Potato Starch | 5.0000 |
| Water | 4.2670 |

It is to be understood that meat analogues embodying features of the present invention may include additional additives and ingredients such as are known in the art. By way of example, the meat analogues may contain food colorings to enhance visual appearance and approximate the coloring of a meat product.

Throughout this description and in the appended claims, it is to be understood that elements referred to in the singular (e.g., a textured vegetable protein, a seasoning, etc.), refer to one or a plurality of such elements, regardless of the tense employed.

The foregoing detailed description and accompanying drawings have been provided by way of explanation and illustration, and are not intended to limit the scope of the appended claims. Many variations in the presently desirable embodiments illustrated herein will be obvious to one of ordinary skill in the art, and remain within the scope of the appended claims and their equivalents.

1. A method of preparing a meat analogue comprising:
hydrating a textured vegetable protein to form a hydrated textured vegetable protein;
preparing a protein base comprising vital wheat gluten, milk-derived protein, and water; and
combining the hydrated textured vegetable protein and the protein base.

2. The invention of claim 1 wherein the textured vegetable protein comprises textured wheat protein.

3. The invention of claim 1 further comprising forming a binder and adding the binder to the hydrated textured vegetable protein and the protein base.

4. The invention of claim 3 wherein the binder comprises water and at least one of methylcellulose, modified cornstarch, partially hydrogenated solid fat, and hydrogenated solid fat.

5. The invention of claim 3 wherein the binder comprises water, methylcellulose, modified cornstarch, and hydrogenated solid fat.

6. The invention of claim 1 further comprising adding seasoning to the hydrated textured vegetable protein and the protein base.

7. The invention of claim 1 further comprising mixing the hydrated textured vegetable protein and the protein base until the meat analogue has a consistent appearance.

8. The invention of claim 1 further comprising shaping the meat analogue into a food product.

9. A method of preparing a meat analogue comprising:
adding a first portion of water to a textured wheat protein to form a hydrated textured wheat protein;
preparing a protein base comprising a powdered protein base and a second portion of water, wherein the powdered protein base comprises vital wheat gluten and milk-derived protein;
forming a binder comprising a vegetable fat, a third portion of water, and a component selected from the group consisting of modified cellulose, modified cornstarch, and a combination thereof; and
combining the hydrated textured wheat protein, the protein base, and the binder.

10. The invention of claim 9 further comprising blending the hydrated textured wheat protein, the protein base, and the binder in a blender until the meat analogue has a consistent appearance.

11. The invention of claim 9 wherein the powdered protein base comprises from about 3% to about 7% by weight of the meat analogue and the second portion of water comprises from about 6% to about 9% by weight of the meat analogue.

12. The invention of claim 9 wherein the vital wheat gluten comprises from about 75% to about 95% by weight of the powdered protein base, and the milk-derived protein comprises from about 5% to about 25% by weight of the powdered protein base.

13. The invention of claim 9 wherein the textured wheat protein comprises from about 5% to about 25% by weight of the meat analogue and the first portion of water comprises from about 20% to about 50% by weight of the meat analogue.

14. The invention of claim 9 wherein the modified cellulose is methylcellulose and wherein the vegetable fat is hydrogenated solid fat.

15. The invention of claim 14 wherein the methylcellulose comprises from about 3% to about 7% by weight of the meat analogue, the modified cornstarch comprises from about 3% to about 7% by weight of the meat analogue, the hydrogenated solid fat comprises from about 7% to about 13% by weight of the meat analogue, and the third portion of water comprises from about 3% to about 6% by weight of the meat analogue.

16. The invention of claim 9 wherein the hydrated textured wheat protein is formed by soaking the textured wheat protein in the first portion of water for a time between about 8 and about 12 hours.

17. A method of preparing a meat analogue comprising:
adding a first portion of water to a textured wheat protein to form a hydrated textured wheat protein, wherein the textured wheat protein comprises from about 5% to about 25% by weight of the meat analogue and the first portion of water comprises from about 20% to about 50% by weight of the meat analogue;
preparing a protein base comprising a powdered protein base and a second portion of water, wherein the powdered protein base comprises vital wheat gluten and milk-derived protein, the powdered protein base comprises from about 3% to about 7% by weight of the meat analogue, and the second portion of water comprises from about 6% to about 9% by weight of the meat analogue;
forming a binder comprising hydrogenated solid fat, a third portion of water, and a component selected from the group consisting of methyl cellulose, modified cornstarch, and a combination thereof, wherein the methylcellulose comprises from about 3% to about 7% by weight of the meat analogue, the modified cornstarch comprises from about 3% to about 7% by weight of the meat analogue, the hydrogenated solid fat comprises from about 7% to about 13% by weight of the meat analogue, and the third portion of water comprises from about 3% to about 6% by weight of the meat analogue;
combining the hydrated textured wheat protein, the protein base, and the binder; and
blending the hydrated textured wheat protein, the protein base, and the binder in a blender until the meat analogue has a consistent appearance.

18. A meat analogue prepared by the method of claim 1.

19. A meat analogue prepared by the method of claim 9.

20. A meat analogue prepared by the method of claim 17.

21. A meat analogue comprising:
vital wheat gluten;
milk-derived protein; and
a textured wheat protein.

22. The invention of claim 21 further comprising water.

23. The invention of claim 22 further comprising a binder.

24. The invention of claim 23 wherein the binder comprises hydrogenated solid fat and a component selected from the group consisting of methyl cellulose, modified cornstarch, and a combination thereof.

25. The invention of claim 24 wherein the hydrogenated solid fat has a melting point between about 90° F. and about 120° F.

26. The invention of claim 24 wherein the hydrogenated solid fat comprises a partially hydrogenated mixture of soybean oil and cottonseed oil.

27. The invention of claim 23 further comprising seasoning.

28. A foodstuff comprising a meat analogue comprising vital wheat gluten, milk-derived protein, and a textured wheat protein.

29. A foodstuff comprising a meat analogue prepared by the method of claim 1.

30. A foodstuff comprising a meat analogue prepared by the method of claim 9.

31. A foodstuff comprising a meat analogue prepared by the method of claim 17.
